(19) United States
(12) Patent Application Publication
(10) Pub. No.: US 2026/0058293 A1
(43) Pub. Date: Feb. 26, 2026

(54) GAS-TIGHT TRACK-ETCHED MEMBRANES FOR EMERGENCY VENTING

(71) Applicant: OXYPHEN GMBH, Lottstetten (DE)

(72) Inventors: Vassili ALFIMOV, Lottstetten (DE); Stefan SPROLL, Wetzikon (CH); Franz MARTIN, Wetzikon (CH)

(73) Assignee: OXYPHEN GMBH, Lottstetten (DE)

(21) Appl. No.: 19/104,552

(22) PCT Filed: Aug. 23, 2023
(86) PCT No.: PCT/EP2023/073097

§ 371 Date: Feb. 18, 2025

(30) Foreign Application Priority Data
Aug. 31, 2022 (EP) 22193267.6

(51) Int. Cl. H01M 50/342

(52) U.S. Cl. CPC H01M 50/3425

(57) ABSTRACT

The invention provides a gas-tight membrane for use as a burst membrane, especially for emergency venting in connection with batteries, e.g. for cars, e-bikes, handheld devices, electronic cigarettes, energy storing devices or heavy-duty tools. The membrane comprises a basic membrane having indentations obtained by an incomplete track-etch treatment applied to the basic membrane. Further, the invention provides a method for preparing the gas-tight membrane by an incomplete track-etch treatment applied to both sides of a basic membrane.

The present invention relates to a gas-tight membrane comprising a basic membrane having indentations on one or both sides of the membrane, a method for producing the gas-tight membranes of the present invention as well as their use as burst membranes in various application forms.

### BACKGROUND OF THE INVENTION

Production of “classical” track-etched membranes (TEM) comprises high energetic heavy ion irradiation of polymer foils with subsequent activation of latent tracks, for example, by UV light, as well as an etching treatment performed afterwards. The production of TEM which are currently commercially available in significant volumes is focused on delivering go-through pores that penetrate through the complete thickness of a membrane and which pores have the highest possible homogeneity of pore sizes and pore densities throughout hundreds of square meters of membrane. Exemplary methods for producing track-etched membranes are described in the publications listed below or, in patent documents like U.S. Pat. No. 3,612,871 B2, DD-AP 235923 and DE 195 36 033 A1.

It was long known that, if some production requirements for the commonly used TEM are not fully followed, the produced TEM could have pores that are not fully developed or which are non-homogeneously distributed. Such waste by-products of the typical TEM production were not considered as commercially attractive before and have not been optimized for commercialization.

### SUMMARY OF THE INVENTION

The present invention aims at providing gas-tight track-etched membranes, which are useful as burst membranes in a number of applications. Thus, in a first aspect, the present invention relates to the use of a gas-tight membrane comprising a basic membrane having indentations on one or both sides of the membrane, which indentations are partially developed pores obtained by an incomplete track-etch treatment applied to the basic membrane, as a burst membrane, especially for emergency venting in connection with batteries, e.g. for cars, e-bikes, handheld devices, electronic cigarettes, energy storing devices or heavy duty tools.

In a second aspect, the present invention relates to a gas-tight membrane suitable for the above use as a burst membrane, said gas-tight membrane having indentations both sides of the membrane, which indentations are partially developed pores, the pores on both sides having an asymmetrical orientation against each other.

In a third aspect, the present invention relates to a method for producing the inventive gas-tight membrane by an incomplete track-etching treatment applied to both sides of a basic membrane, in which the incomplete track-etching treatment comprises steps including an irradiation treatment by heavy ions with a lower energy than needed to penetrate the whole thickness of the basic membrane, optionally a subsequent activation with UV or DMF, and an etching step, to obtain indentations on both sides of the basic membrane, wherein the incomplete track-etch treatment is performed under conditions preventing the formation of pores that completely penetrate the membrane.

### DETAILED DESCRIPTION

The invention presented here describes a novel kind of gas-tight track-etched membranes (GT TEM) that was not available before. Through certain targeted manipulations of production parameters, a range of GT TEMs could be produced which contain partially developed pores that do not go through the complete thickness of the membrane. The manipulation of the production parameters sets certain penetration depths of the partially developed pores and, what is more crucial for the intended application for emergency renting, a certain thickness of the pore-free “bridge” between two sides of partially developed pores. The thickness of the “bridge” but also the shape and density of pores provided on the membrane correlates to the force that is necessary to burst the membrane.

A gas-tight membrane used as a burst membrane according to the invention can have partially developed pores on one side as exemplified in FIG. 1. Alternatively, the membranes used as burst membranes can have partially developed pores on both sides of the membrane as exemplified by FIG. 2. FIG. 2 shows a symmetrical orientation of the pores against each other and also a symmetrical orientation of the pore depths with relation to the remaining “bridge”. However, further preferred embodiments of the present invention include asymmetrical orientations of the pore depths with regard to the “bridge” as exemplified by FIG. 3 or against each other and optionally also against the “bridge” as exemplified by FIG. 4. All conceivable sizes, depth and relative configurations of pores on one or both sides of the membrane are considered as within the scope of the present invention and the choice of the appropriate configuration can easily be made by the skilled person based on the intended use of the gas-tight membrane as a burst membrane.

The pores of the gas-tight membrane used as a burst membrane according to the present invention are preferably of conical or cylindrical shape. Furthermore, the pores on the different sides of the membrane can have the same or different penetration depth, again leading to a symmetrical or asymmetrical configuration in relation to the “bridge” between two sides of partially developed pores or one side of partially developed pores and one side without pores.

The gas-tight membrane used as a burst membrane can have a pore density and also pore sizes in the same range as usually applied for the “classical” track-etched membranes, however the difference is that, according to the invention, the pores do not fully penetrate the membrane, but only are present as indentation on one or both sides. In preferred embodiments, the gas-tight membrane used as a burst membrane shows 1,000 to 1×10¹⁰ partially developed pores per cm², preferably the gas-tight membrane has 1×10⁶ to 5×10⁸ of such indentations or partially developed pores per cm². Such number of partially developed pores can be present on one or both sides of the membrane and pore density can be the same for both sides of the membrane, or different. The determination of pore density can be done on electron microscope, on two about 0.5 cm² samples, with 6-12 spatially distributed pictures with 100-400 pores per picture. This pore density can then be correlated to the continuous online current measurements during the irradiation that reflect the pore density across the whole length of membrane.

Also in view of the pore size, the gas-tight membrane used as a burst membrane according to the present invention closely resembles the known “classical” track-etched membranes and can have the same pore sizes on the surface, preferably pore sizes of 0.1 to 20 μm, preferably 1 to 10 μm, again the important difference being that for the inventive gas-tight membrane the pores do not fully penetrate the membrane. For cylindrical pore shapes, the pore size is consistent from the membrane surface to the bottom of the pore, whereas for conical pore shapes, the pore size on the surface has the largest diameter and tapers towards the bottom of the pore. Also the pore sizes can be the same of both sides of a membrane having indentations on both sides, or different.

For many applications of membranes, it is important that pores are distributed particularly evenly and, according to the present invention, gas-tight membranes preferably used as a burst membrane show a standard deviation of the distribution of partially developed pores per square unit of a maximum of 30%, preferably of 1 to 10% and most preferably between 2 and 5%, considered independently for both sides of the membrane, as measured with the online current measurement during the irradiation. Within the context of this invention, the square unit refers to any appropriate square size for which the standard deviation of the distribution of the pores is determined.

In a similar manner, the pore size is preferably also highly uniform and homogeneous over the membrane area and in especially preferred embodiments of the invention, the standard deviation of pore size varies between 3% and 10%. Especially, the homogeneity and uniformity of pore distribution and pore size can be an important factor for use as a burst membrane. Considering the preferred embodiments regarding these features, the invention allows to arrive at a deviation of a medium burst pressure applied to the membrane of equal to or below 50%, preferably equal to or below 25% and most preferably equal to or below 20%, again, the property independently applies to each of both sides of the membrane. Burst pressure can be measured by sealing ø25 mm membrane discs with O-rings and applying an increasing water under pressure until the membrane breaks and give a leakage that is detected via electrical contact above and below membrane.

Considering the various membrane configurations described above, it is evident that the membrane used as a burst membrane can comprise partially developed pores on both sides of the basic membranes in a manner, which provides for different burst pressures for the different sides. This is especially the case if the pore depth on both sides is different, however, also the pore density on both sides as well as other factors influencing the burst pressure can vary. It can be highly advantageous to use such membrane configurations to achieve different burst pressure sensitivity depending on whether the pressure is applied from the one or the other side.

As with classical track-etched membranes, also the gas-tight membranes used as burst membranes according to the present invention can be made of a membrane material selected from polyethylene terephthalate (PET), polycarbonate (PC), polyimide (PI), polyvinylidene fluoride (PVDF), polyethylene naphthalate (PEN), polyether ether ketone (PEEK), ethylene tetrafuoroethylene (ETFE) and other polymers or composite materials having similar properties. Based on the properties of PET and the fact that this material is environmentally friendly, however also based on its burst properties, PET is the most preferred membrane material of the present invention.

The membrane thickness can be adapted and chosen according to the intended use. Within the context of the present invention, usually membrane thicknesses are between 5 and 200 μm, a preferred membrane thickness, especially for burst membranes, is 10 to 75 μm.

Again, depending on the desired sensitivity of the membrane, the pore-free “bridge” of the membrane material usually constitutes between 10 and 50% of the thickness of the basic membrane, however, depending on the intended application, also higher or lower values can apply.

It will be apparent to the skilled person that many of the above explanations regarding preferred embodiments apply to specific circumstances and especially the particular use of the membrane as a burst membrane. For a specific application as a burst membrane, adaptions and variations of such preferred embodiments might be required and advantageous. Such adaptions and variations can be easily made by the skilled person based on his knowledge and the overall information provided herewith.

Burst membranes are typically used in devices, in which malfunctions or external conditions can lead to increased pressure or other circumstances, which can damage the device or which can endanger surrounding objects or articles. A burst membrane can be used in safety engineering and in applications like pressure sensors, however also in explosion pressure absorption systems and the membranes can protect against fire and detonation.

Accordingly, preferred uses of the gas-tight membranes as burst membranes include applications in emergency venting, especially in connection with batteries, e.g. for cars, e-bikes, hand-held devices, energy storing devices or heavy duty tools. Also other applications, in which overpressure can be prevented by the bursting of a respective material in a predefined fashion to enable a controlled deflation are potential uses of the membranes, e.g., in automobile airbags.

The above membranes can be used for such application as described above with an external trigger like a needle, edge or similar as well as without an external trigger. In the latter case, the above membrane bursts based on its own perforation as the membrane includes millions and millions of weak points which give way in response to the applied pressure.

According to a second aspect, the present invention provides a gas-tight membrane particularly suitable for the above use as a burst membrane. Said gas-tight membrane comprises a basic membrane having indentations both sides of the membrane, which indentations are partially developed pores, the pores on both sides having an asymmetrical orientation against each other.

The other properties of the membrane correspond to the above description in connection with the intended use as a bursting membrane. A gas-tight membrane according to the second aspect of the invention can have about 1,000 to 1×10¹⁰ partially developed pores per cm², preferably 1×10⁶ to 5×10⁸ partially developed pores per cm² on both sides of the membrane. The pore size can be about 0.1 to 20 μm, preferably 1 to 10 μm, as determined by electron microscopy.

The standard deviation of the distribution of partially developed pores per square unit is preferably up to 30%, more preferably from 1% to 10% and typically between 2% to 5%. The standard deviation of pore size is preferably between 3% and 10%. The deviation of a median burst pressure is preferably equal to or below 50%, more preferably equal to or below 25% and most preferably equal to or below 20%.

The membrane material can be selected from polyethylene terephthalate (PET), polycarbonate (PC), polyimide (PI), polyvinylidene fluoride (PVDF), polyethylene naphthalate (PEN), polyether ether ketone (PEEK), and ethylene tetrafuoroethylene (ETFE).

The membrane thickness lies preferably between 5 and 100 μm, more preferably 10 to 75 μm. A pore-free bridge of membrane material may constitute between 10% and 50% of the thickness of the basic membrane.

The penetration depth of the pores on different sides of the membrane can be the same or different. The pores can have a conical or cylindrical shape, wherein the shape can differ on the different sides of the membrane or be the same. Other properties such as the number of pores, density of the pores, etc. can also be the same or different for both sides. Different properties of the two sides are advantageous, for example, if the pressure at which the membrane bursts is to be higher on one side than on the other. Thus, according to a particularly preferred aspect of the invention, the gas-tight membrane comprises partially developed pores on both sides of the membrane in a manner, which provides for different burst pressures for the different sides.

Regarding the third aspect of the present invention, i.e., a method for producing the above gas-tight membrane, such method includes an incomplete track-etch treatment, which is applied to both sides of a basic membrane. Such incomplete track-etch treatment includes the steps of an irradiation treatment by heavy ions with a lower energy than needed for the heavy ions to penetrate the whole thickness of the basic membrane. Optionally, subsequent UV activation can be performed as is state of the art to produce track-etched membranes. Furthermore, and a standard step in the production of the classic membranes with fully developed pores, an etching treatment step is carried out for removing the polymer material contained in the latent tracks formed by the heavy ion treatment and optional subsequent UV activation, to obtain indentations on both sides of the basic membrane.

The incomplete track-etch treatment is performed under conditions preventing the formation of pores that completely penetrate the thickness of the basic membrane. The energy of heavy ions is chosen too low for a complete penetration through the polymer membrane material. Furthermore, the production process can be performed with or without subsequent UV activation. Omitting the UV activation step is also one of the possibilities to inhibit complete penetration of the membrane by pores. In the above cases, a complete penetration of the pores is avoided due to the low energy of the heavy ions, and optionally additionally due to the lack of UV activation or the insufficiency thereof. Also, the oxygen concentration during the UV activation treatment can be adjusted to avoid development of completely penetrating pores.

Finally, also the etching step can be adapted in order to avoid complete pore development. E.g., the etching is stopped before the pores go completely through the thickness of the membrane and a less strong etching solution can be applied.

A gas-tight membrane having partially formed pores on both sides as, e.g., shown in FIG. 2 can be produced if the energy of the heavy ions is high enough for complete penetration through the polymer material. The latent tracks are then left completely or partially undeveloped by applying too little or no UV activation and/or too little or no oxygen concentration and/or incomplete etching to both sides.

Depending on the conditions applied to each side of the membrane, a symmetrical or an asymmetrical membrane can be obtained. Asymmetry can also be added through a protective layer on one side or through application of different etching conditions to the two sides of a polymer foil. The etching is again stopped before the pores completely penetrate the thickness of the membrane.

As a further option, an asymmetrical version of gas-tight track-etched membrane could also be generated by the combination of irradiations with different ion species or energies of these ions on one side or on both sides to generate different latent tracks in the polymer foils (as in FIG. 4). These tracks are then underdeveloped as described above and the etching is stopped before the pores go completely through the thickness of the membrane.

Based on the above examples, the skilled person will easily appreciate that adapting the conditions for producing classical track-etched membranes as outlined above, all sorts of different configurations and variations of gas-tight membranes for use according to the invention can be obtained. As applicable with regard to the description of the gas-tight membranes themselves, also for the inventive method for production, the features and conditions can easily be adapted to provide the best possible gas-tight membrane for the intended use.

The following Examples and Figures further illustrate the invention:

### FIGURES

FIG. 1 shows a one-sided gas-tight track-etched membrane (symbolical representation, the tracks can be conical or cylindrical);

FIG. 2 shows a two-sided gas-tight symmetrical track-etched membrane (symbolical representation, the tracks can be conical or cylindrical);

FIG. 3 shows a two-sided gas-tight asymmetrical track-etched membrane (symbolical representation, the tracks can be conical or cylindrical);

FIG. 4 shows a two-sided gas-tight asymmetrical track-etched membrane produced as double-version of FIG. 1 (symbolical representation, the tracks can be conical or cylindrical); and

FIG. 5 shows a scanning electron microscope image with a cross section of gas-tight track-etched membrane

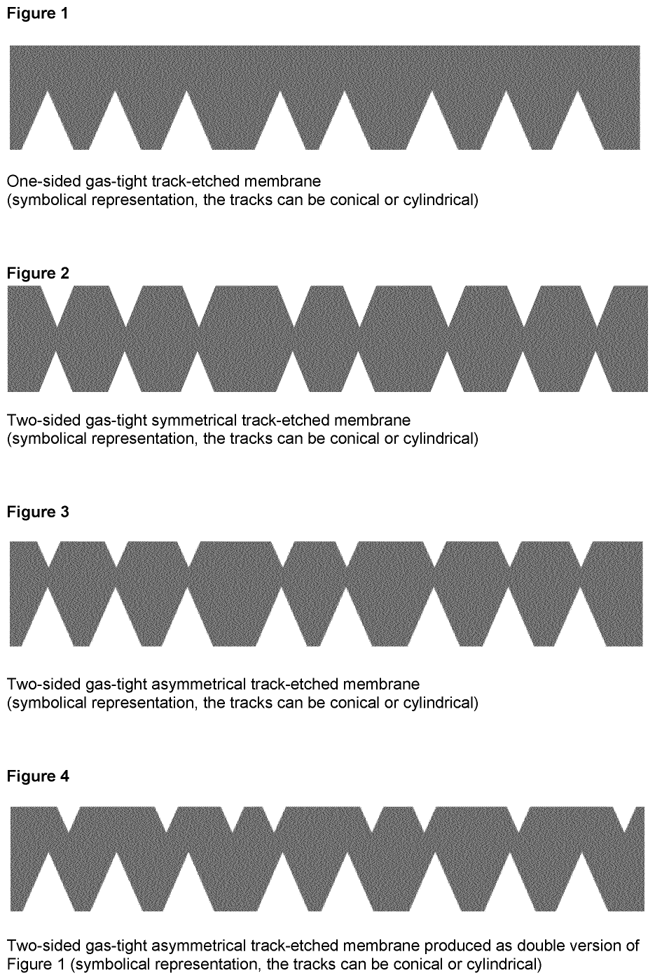

### EXAMPLE

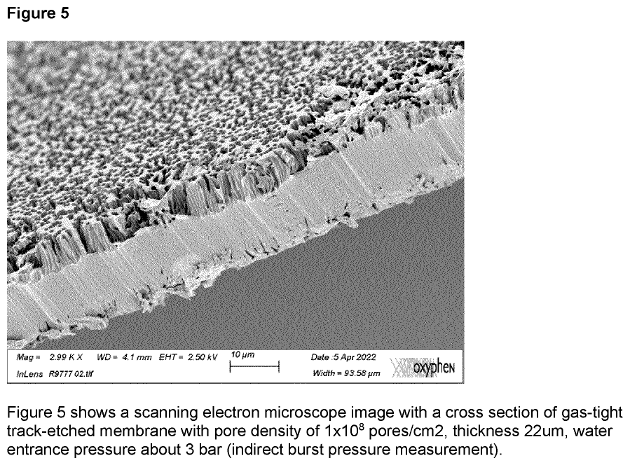

A raw PET foil (23 μm thickness, Mitsubishi Hostaphan RN MED) was irradiated with heavy ions (Kr) at the accelerator. The UV activation of latent tracks was on purpose avoided. The irradiated foil was then etched, but the etching was stopped, before the etching fronts from both sides of the membrane met each other and the pores were developed into go-through pores. The control of the etching was done with airflow measurements and water entry pressure measurements. These and other applicable measurements can be used to control the production and grade the membrane for different burst pressures, depending on the configuration of test setup. FIG. 5 shows a scanning electron microscope image with a cross section of gas-tight track-etched membrane with pore density of 1×10⁸ pores/cm², thickness 22 μm, water entrance pressure about 3 bar (indirect burst pressure measurement). The burst pressure is measured by sealing ø 25 mm membrane discs with O-rings and applying an increasing water under pressure until the membrane breaks and give a leakage that is detected via electrical contact above and below membrane.

### LIST OF REFERENCES

Apel P. Yu. and Dmitriev S. N. (2011), Micro-and nanoporous materials produced using accelerated heavy ion beams, Adv. Nat. Sci: Nanosci. Nanotechnol. 2 (2011) 013002 http://iopscience.iop.org/2043-6262/2/1/013002;
Apel P. (2001), Track etching technique in membrane technology, Radiation measurements 34, pp 559-566;
Fischer B. E. and Spohr R. (1983), Production and use of nuclear tracks: imprinting structure on solids, Rev. Mod. Phys. 55 907;
Spohr R. (1997) Ion track technology—a persisting challenge, New Astronomy Reviews 42 (1998) 189-203;
Apel P. Yu. (1995) Heavy particle tracks in polymers and polymeric track membranes, Radiation measurements 25, 1-4, pp 667-674 (1995);
Spohr R. (2001), Etch hints for polymers with high track-etch-rate, European Research Training Network EuNITT, Report M2.1;
DeSorbo W. (1979), Ultraviolet effects and aging effect on etching characteristics of fission tracks in polycarbonate film, Nucl. Tracks, Vol. 3, pp 13-32, 1979;
Spohr R. (2009), Ion Tracks for micro and nanofabrication, Uppsala PhD Thesis 700, http://kth. diva-portal. org/smash/get/diva2:280068/FULLTEXT02.pdf.

1. Use of a gas-tight membrane comprising a basic membrane having indentations on one or both sides of the membrane, which indentations are partially developed pores obtained by an incomplete track-etch treatment applied to the basic membrane as a burst membrane, especially for emergency venting in connection with batteries, e.g. for cars, e-bikes, handheld devices, electronic cigarettes, energy storing devices or heavy-duty tools.

2. Gas-tight membrane suitable for the use according to claim 1, comprising a basic membrane having indentations both sides of the membrane, which indentations are partially developed pores, the pores on both sides having an asymmetrical orientation against each other.

3. Gas-tight membrane according to claim 2, wherein the pores have a conical or cylindrical shape.

4. Gas-tight membrane according to claim 2, wherein the pores on different sides of the membrane have the same or different penetration depth.

5. Gas-tight membrane according to claim 2, having 1,000 to 1×10¹⁰ partially developed pores per cm², preferably 1×10⁶ to 5×10⁸ partially developed pores per cm² on one or both sides of the membrane and/or wherein the pore size is 0.1 to 20 μm, preferably 1 to 10 μm, as determined by electron microscopy.

6. Gas-tight membrane according to claim 2, wherein the standard deviation of the distribution of partially developed pores per square unit is up to 30%, preferably from 1% to 10% and typically between 2% to 5%.

7. Gas-tight membrane according to claim 2, wherein the standard deviation of pore size is between 3% and 10% and/or wherein the deviation of a median burst pressure is equal to or below 50%, preferably equal to or below 25% and most preferably equal to or below 20%.

8. Gas-tight membrane according to claim 2, wherein the membrane comprises partially developed pores on both sides of the membrane in a manner, which provides for different burst pressures for the different sides.

9. Gas-tight membrane according to claim 2, wherein the membrane material is selected from polyethylene terephthalate (PET), polycarbonate (PC), polyimide (PI), polyvinylidene fluoride (PVDF), polyethylene naphthalate (PEN), polyether ether ketone (PEEK), and ethylene tetrafuoroethylene (ETFE).

10. Gas-tight membrane according to claim 2, wherein the membrane thickness lies between 5 and 200 μm, preferably 10 to 75 μm, and/or wherein a pore-free bridge of membrane material constitutes between 10% and 50% of the thickness of the basic membrane.

11. Method for producing a gas-tight membrane according to claim 2 by an incomplete track-etch treatment applied to both sides of a basic membrane, in which the incomplete track-etch treatment comprises the steps:
an irradiation treatment by heavy ions with a lower energy than needed to penetrate the whole thickness of the basic membrane,
optionally a subsequent UV activation, and
an etching treatment,
to obtain indentations on both sides of the basic membrane,
wherein the incomplete track-etch treatment is performed under conditions preventing the
formation of pores that completely penetrate the thickness of the basic membrane.

12. Method according to claim 11, wherein the basic membrane comprises a polymer foil such as a PET, PC, PI, PEN, PVDF, PEEK, or ETFE foil.

13. The method according to claim 11, wherein track-etch treatment on both sides of the basic membrane is carried out under the same of different conditions, in particular using the same or different ion energy in the irradiation treatment and/or the same of different time and conditions in the etching treatment.
